(19) United States
(12) Patent Application Publication
(10) Pub. No.: US 2025/0347785 A1
(43) Pub. Date: Nov. 13, 2025

(54) INCREASING RANGE OF IMAGING SYSTEMS

(71) Applicant: SiLC Technologies, Inc., Monrovia, CA (US)

(72) Inventors: Vala Fathipour, Pasadena, CA (US); Mehdi Asghari, La Canada Flintridge, CA (US); Prakash Koonath, La Crescenta, CA (US); Nirmal Chindhu Warke, Saratoga, CA (US)

(21) Appl. No.: 18/660,141

(22) Filed: May 9, 2024

(51) Int. Cl. G01S 7/4911; G01S 7/4912; G01S 17/34

(52) U.S. Cl. CPC G01S 7/4911; G01S 7/4912; G01S 17/34

(57) ABSTRACT

A LIDAR system includes a signal splitter configured to receive an outgoing LIDAR signal. The LIDAR system transmits a system output signal that includes light from the outgoing LIDAR signal received by the splitter. The LIDAR system includes a light signal combiner configured to combine light that returns to the LIDAR system from the system output signal with light from a reference signal so as to generate a composite signal beating at a beat frequency. The reference signal includes light from the outgoing LIDAR signal received by the splitter. A length of an optical pathway from the splitter to the light signal combiner is increased such that the time for the reference signal to travel from the splitter to the light signal combiner is greater than 1 picosecond and less than 1 nanosecond.

### FIELD

The invention relates to optical devices. In particular, the invention relates to LIDAR systems.

### BACKGROUND

There is an increasing commercial demand for LIDAR systems that can be deployed in applications such as ADAS (Advanced Driver Assistance Systems) and AR (Augmented Reality). LIDAR (Light Detection and Ranging) systems typically output a system output signal that is reflected by an object located outside of the LIDAR system. At least a portion of the reflected light signal returns to the LIDAR system. The LIDAR system directs the received light signal to a light sensor that converts the light signal to an electrical signal. Electronics can use the light sensor output to quantify LIDAR data that indicates the radial velocity and/or distance between the object and the LIDAR system.

The span of the radial velocity values and/or distance values that can be reliably calculated by the LIDAR system is often limited by the performance of the electronics in the LIDAR system. As a result, there is a need to increase the range for the radial velocity values and/or distance values that can be calculated by LIDAR systems.

### SUMMARY

A LIDAR system includes a signal splitter configured to receive an outgoing LIDAR signal. The LIDAR system transmits a system output signal that includes light from the outgoing LIDAR signal received by the splitter. The LIDAR system also includes a light signal combiner configured to combine light that returns to the LIDAR system from the system output signal with light from a reference signal so as to generate a composite signal beating at a beat frequency. The reference signal includes light from the outgoing LIDAR signal received by the splitter. A length of an optical pathway from the splitter to the light signal combiner is increased such that the time for the reference signal to travel from the splitter to the light signal combiner is greater than 1 picosecond and less than 1 nanosecond.

A LIDAR system includes a signal splitter configured to receive an outgoing LIDAR signal. The LIDAR system transmits a system output signal that includes light from the outgoing LIDAR signal received by the splitter. The LIDAR system includes a light signal combiner configured to combine light that returns to the LIDAR system from the system output signal with light from a reference signal so as to generate a composite signal beating at a beat frequency. The reference signal includes light from the outgoing LIDAR signal received by the splitter. A length of an optical pathway from the splitter to the light signal combiner is greater than 0.086 mm and less than 0.086 m.

A LIDAR system includes a signal splitter configured to receive an outgoing LIDAR signal. The LIDAR system transmits a system output signal that includes light from the outgoing LIDAR signal received by the splitter. The LIDAR system includes a light signal combiner configured to combine light that returns to the LIDAR system from the system output signal with light from a reference signal so as to generate a composite signal beating at a beat frequency. The reference signal includes light from the outgoing LIDAR signal received by the splitter. The splitter outputs a portion of the outgoing LIDAR signal that travels an optical pathway from the splitter to a location where the portion of the outgoing LIDAR signal is transmitted from the LIDAR system as the system output signal. The optical pathway from the splitter to the location where the portion of the outgoing LIDAR signal is transmitted from the LIDAR system includes a misdirection source that reflects a misdirected portion of the first portion of the outgoing LIDAR signal that serves as a misdirected signal. The misdirected signal is received at the light signal combiner. The LIDAR system is constructed such that the time for the reference signal to travel from the splitter to the light signal combiner is greater than or equal to 30% and less than or equal to 100% of the time for light included in the misdirected signal to travel from the splitter, to the misdirection source, and to the light signal combiner.

### BRIEF DESCRIPTION OF THE FIGURES

FIG. 1 is a topview of a schematic of a LIDAR chip.

FIG. 2 is a topview of an example of a LIDAR adapter that is suitable for use with the LIDAR chip of FIG. 1.

FIG. 3 is a topview of an example of a LIDAR assembly that includes the LIDAR chip of FIG. 1 and the LIDAR adapter of FIG. 2 on a common support.

FIG. 4 is a topview of an example of a LIDAR system that includes the LIDAR assembly of FIG. 3 used in conjunction with system components.

FIG. 5A illustrates an example of local optical components suitable for use with the LIDAR systems.

FIG. 5B provides a schematic of electronics that are suitable for use with local optical components configured according to FIG. 5A.

FIG. 5C is a graph of frequency versus time for a system output signal with triangular frequency tuning.

FIG. 6 illustrates an example of the output of mathematical transformer when an external object does not reflect a system output signal transmitted by the LIDAR system.

FIG. 7A illustrates a frequency versus time patterns for multiple different signals that are processed by the LIDAR system.

FIG. 7B illustrates a frequency versus time patterns for multiple different signals that are processed by the LIDAR system.

FIG. 8 is a cross-section of portion of a LIDAR chip that includes a waveguide on a silicon-on-insulator platform.

### DESCRIPTION

The LIDAR system includes a splitter that receives an outgoing LIDAR signal. The LIDAR system transmits a system output signal that includes light from the outgoing LIDAR signal received by the splitter. The system output signal can be reflected by an object that is external to the LIDAR system. A portion of the reflected light can return to the LIDAR system in a system return signal. The LIDAR system includes a light signal combiner that combines light from the system return signal with a reference signal that includes light from the outgoing LIDAR signal received by the splitter. The light signal combiner combines the light from the system return signal with the reference signal so as to generate a composite signal beating at a beat frequency. The LIDAR system includes electronics that use the beat frequency to calculate LIDAR data for the object. The LIDAR data indicates the distance and/or the radial velocity between the LIDAR system and the object.

The span of values that the LIDAR system can calculate for the distance and/or the radial velocity between the LIDAR system and the object is limited by the range of beat frequency values that the LIDAR system can reliably calculate. The range of beat frequency values that the LIDAR system can reliably calculate extends from a lower beat frequency limit to an upper beat frequency limit. Extending the length of the pathway that the reference signal travels from the splitter to the light signal combiner can shift the lower beat frequency limit to lower values. The shift of the lower beat frequency limit to lower values increases the range of beat frequency values that the LIDAR system can reliably calculate and accordingly increases the span of values that the LIDAR system can calculate for the distance and/or the radial velocity.

Additionally, the LIDAR system can reflect light from the outgoing LIDAR before the outgoing LIDAR signal is transmitted from the LIDAR system as a system output signal. These reflections can be considered system reflections that are a source of noise in the composite signal. These system reflections can elevate the noise floor of the composite signal. The LIDAR system can optionally include filters configured to reduce the noise floor in the composite signal. The reduction in the noise floor decreases the lower beat frequency limit. The decreased lower beat frequency limit further increases the span of values that the LIDAR system can calculate for the distance and/or the radial velocity.

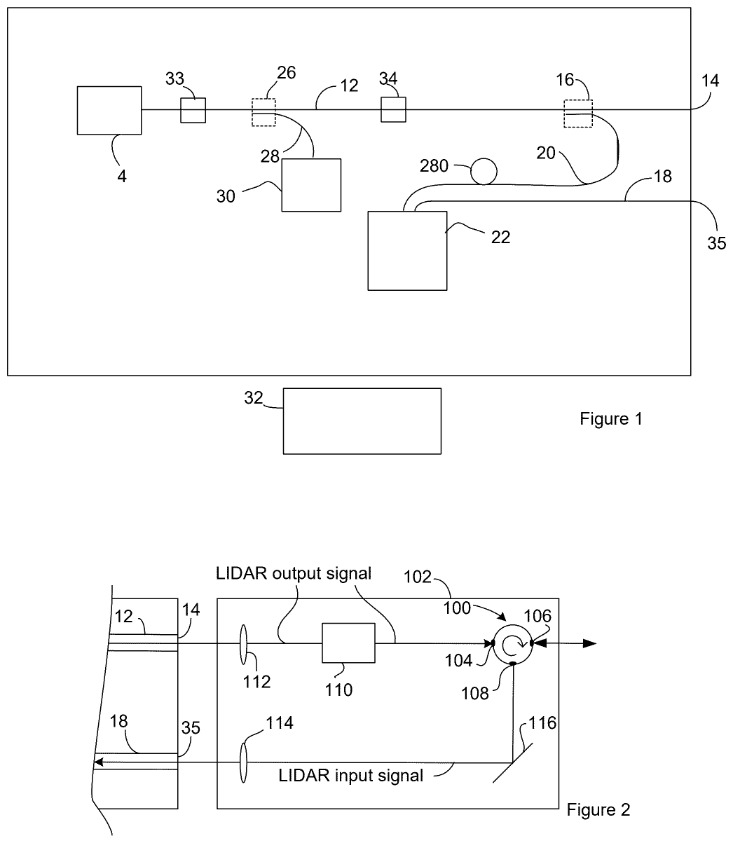

FIG. 1 is a topview of a schematic of a LIDAR chip that can serve as a LIDAR system or can be included in a LIDAR system that includes components in addition to the LIDAR chip. The LIDAR chip can be a semiconductor chip that includes a Photonic Integrated Circuit (PIC) and can be a Photonic Integrated Circuit chip. The LIDAR chip includes a light source 4 that outputs an outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal. In some instances, the portion of the LIDAR output signal that has exited from the LIDAR chip can also be considered a system output signal. As an example, when the exit of the LIDAR output signal from the LIDAR chip is also an exit of the LIDAR output signal from the LIDAR system, the LIDAR output signal can also be considered a system output signal.

The LIDAR output signal travels away from the LIDAR system through free space. The LIDAR output signal may be reflected by one or more objects in the path of the LIDAR output signal. When the LIDAR output signal is reflected, at least a portion of the reflected light travels back toward the LIDAR chip as a LIDAR input signal. In some instances, the LIDAR input signal can also be considered a system return signal. As an example, when the exit of the LIDAR output signal from the LIDAR chip is also an exit of the LIDAR output signal from the LIDAR system, the LIDAR input signal can also be considered a system return signal.

The LIDAR chip includes a comparative waveguide 18 that terminates at a fact 35. The LIDAR input signals enters the LIDAR chip through the facet 35 of the comparative waveguide 18 and serves as a comparative signal. The comparative waveguide 18 carries the comparative signal to an optical signal processor 22 for further processing. The reference waveguide 20 carries the reference signal to the optical signal processor 22 for further processing. As will be described in more detail below, the optical signal processor 22 combines the comparative signal with the reference signal to form a composite signal that carries LIDAR data for a sample region on the field of view.

The LIDAR chip includes a splitter 16 positioned along the utility waveguide 12. The splitter 16 receives the outgoing LIDAR signal and is configured to output a first portion of the outgoing LIDAR on a second portion of the utility waveguide 12. Accordingly, the first portion of the outgoing LIDAR can continue to serve as the outgoing LIDAR signal. The splitter 16 is also configured to output a second portion of the outgoing LIDAR signal on a reference waveguide 20. Suitable splitters 16 include, but are not limited to, directional couplers, optical couplers, y-junctions, tapered couplers, and Multi-Mode Interference (MMI) devices. When the splitter 16 is a directional coupler the splitter 16 moves a portion of the outgoing LIDAR signal from the utility waveguide 12 onto a reference waveguide 20 as a reference signal. The reference waveguide 20 carries the reference signal to the optical signal processor 22 for further processing. Although FIG. 1 illustrates a directional coupler operating as the splitter 16, other signal tapping components can be used as the splitter 16. Suitable splitters 16 include, but are not limited to, directional couplers, optical couplers, y-junctions, tapered couplers, and Multi-Mode Interference (MMI) devices.

The percentage of the outgoing LIDAR signal power output on the reference waveguide 20 by the splitter 16 can be fixed or substantially fixed. For instance, the splitter 16 can be configured such that the power of the reference signal transferred to the reference waveguide 20 is an outgoing percentage of the power of the outgoing LIDAR signal or such that the power of the comparative signal transferred to the comparative waveguide 18 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 16 such as a multimode interferometer (MMI) generally provides an outgoing percentage and an incoming percentage of 50% or about 50%. However, multimode interferometers (MMIs) can be easier to fabricate in platforms such as silicon-on-insulator platforms than some alternatives. In one example, the splitter 16 is a multimode interferometer (MMI) and the outgoing percentage and the incoming percentage are 50% or substantially 50%. As will be described in more detail below, the optical signal processor 22 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a local branch suitable for use in generating a normalized beat frequency and/or controlling operation of the light source 4. The local branch includes a splitter 26 that moves a portion of the outgoing LIDAR signal from the utility waveguide 12 onto a control waveguide 28. The coupled portion of the outgoing LIDAR signal serves as a tapped signal. Although FIG. 1 illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the tapped signal to local optical components 30. The local components 30 can be in electrical communication with electronics 32. All or a portion of the local components 30 can be included in the electronics 32. When the local branch is used in controlling operation of the light source 4, the electronics can employ output from the local components 30 to control a process variable of one, two, or three controlled light signals selected from the group consisting of the tapped signal, the system output signal, and the outgoing LIDAR signal. Examples of the suitable process variables include the frequency of the controlled light signal and/or the phase of the controlled light signal. When the local branch is used in generating a normalized beat frequency, the electronics can employ output from the local optical components 30 to calculate a local beat frequency that is a variable used in calculating the normalized beat frequency.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

In some instances, a LIDAR chip constructed according to FIG. 1 is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the LIDAR input signal and the LIDAR output signal such that the LIDAR input signal and the LIDAR output signal travel on different optical pathways between the LIDAR adapter and the LIDAR chip but on the same optical pathway between the LIDAR adapter and a reflecting object in the field of view.

An example of a LIDAR adapter that is suitable for use with the LIDAR chip of FIG. 1 is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in the sample region reflect the LIDAR output signal, at least a portion of the reflected light travels back to the circulator 100 as a system return signal. The system return signal enters the circulator 100 through the second port 106. FIG. 2 illustrates the LIDAR output signal and the system return signal traveling between the LIDAR adapter and the sample region along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal on the facet 35 of the comparative waveguide 18.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, when traveling between the different components on the LIDAR adapter and/or between a component on the LIDAR adapter and the LIDAR chip, the system return signal and/or the LIDAR output signal can travel through air, vacuum, the atmosphere in which the LIDAR chip, the LIDAR adapter, and/or the base 102 is positioned, or other medium. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

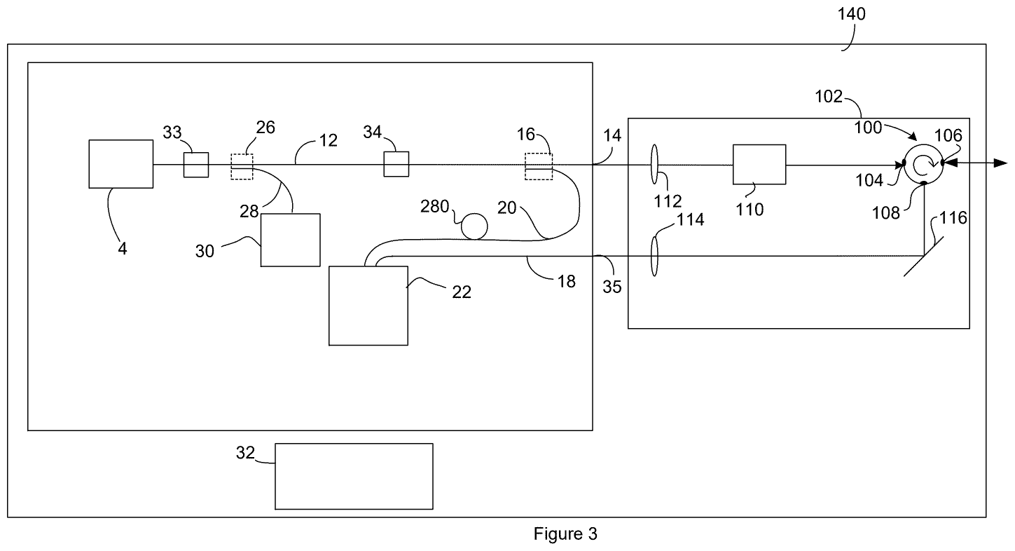

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 3 is a topview of a LIDAR system that includes the LIDAR chip and electronics 32 of FIG. 1 and the LIDAR adapter of FIG. 2 on a common mount 128. Although the electronics 32 are illustrated as being located on the common support, all or a portion of the electronics can be located off the common support. When the light source 4 is located off the LIDAR chip, the light source can be located on the common mount 128 or off the common mount 128.

Although FIG. 3 illustrates the electronics 32 as located on the common mount 128, all or a portion of the electronics can be located off the common mount 128. When the light source 10 is located off the LIDAR chip, the light source can be located on the common mount 128 or off of the common mount 128. Suitable approaches for mounting the LIDAR chip, electronics, and/or the LIDAR adapter on the common mount 128 include, but are not limited to, epoxy, solder, and mechanical clamping. Suitable common mounts 128 include, but are not limited to, substrates such as glass plates, metal plates, silicon plates and ceramic plates.

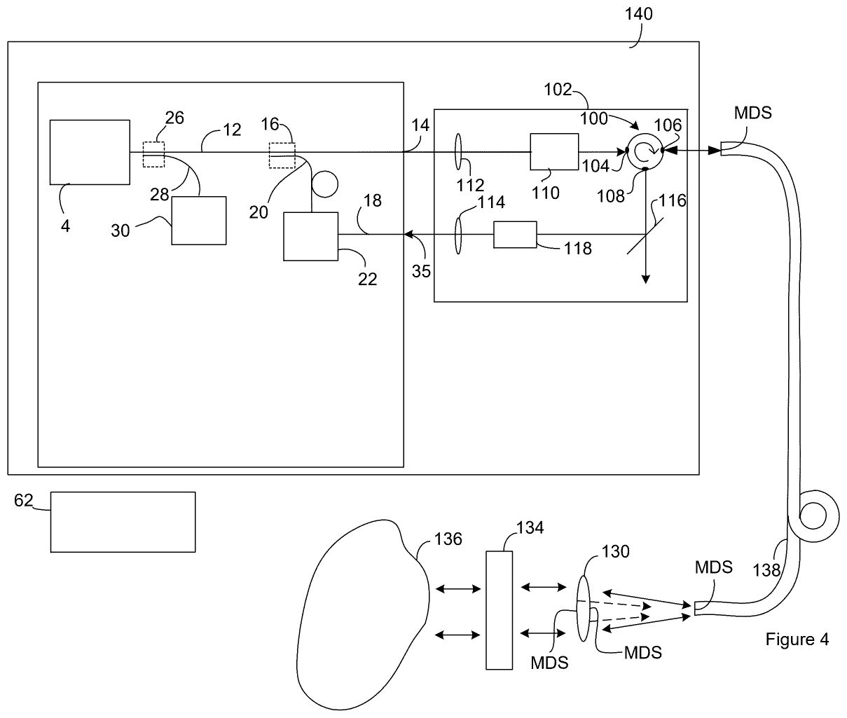

The LIDAR systems of FIG. 3 can include one or more system components that are at least partially located off the common mount 128. For instance, FIG. 4 illustrates a LIDAR system that includes system components in addition to the LIDAR assembly of FIG. 3. Examples of suitable system components include, but are not limited to, optical links, beam shapers, polarization state rotators, beam scanners, optical splitters, optical amplifiers, and optical attenuators. The LIDAR system of FIG. 4 includes one or more beam shapers 130 that receive the LIDAR output signal from the adapter and output a shaped signal. The one or more beam shapers 130 can be configured to provide the shaped signal with the desired shape. For instance, the one or more beam shapers 130 can be configured to output a shaped signal that focused, diverging or collimated. In FIG. 4, the one or more beam shapers 130 is a lens that is configured to output a collimated shaped signal.

The LIDAR systems of FIG. 4 can optionally include one or more beam scanners 134 that receive the shaped signal from the one or more beam shapers 130 and that output the system output signal. For instance, FIG. 4 illustrates a beam scanner 134 that receives the rotated signal from a polarization rotator 132. The electronics can operate the one or more beam scanners 134 so as to steer the system output signal to different sample regions 135. The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

Suitable beam scanners include, but are not limited to, movable mirrors, MEMS mirrors, optical phased arrays (OPAs), optical gratings, actuated optical gratings and actuators that move the LIDAR chip, LIDAR adapter, and/or common mount 128.

When the system output signal is reflected by an object 136 located outside of the LIDAR system and the LIDAR, at least a portion of the reflected light returns to the LIDAR system as a system return signal. When the LIDAR system includes one or more beam scanners 134, the one or more beam scanners 134 can receive at least a portion of the system return signal from the object 136. The one or more beam shapers 130 receive the system return signal from the one or more beam scanners 134 and output a shaped system return signal that is received by the adapter.

The LIDAR system of FIG. 4 includes an optional optical link 138 that carries optical signals to the one or more system components from the adapter, from the LIDAR chip, and/or from one or more components on the common mount. For instance, the LIDAR system of FIG. 4 includes an optical fiber configured to carry the assembly output signal to the beam shapers 130. The use of the optical link 138 allows the source of the system output signal to be located remote from the LIDAR chip. Although the illustrated optical link 138 is an optical fiber, other optical links 138 can be used. Suitable optical links 138 include, but are not limited to, free space optical links and waveguides. When the LIDAR system excludes an optical link, the one or more beam shapers 130 can receive the assembly output signal directly from the adapter.

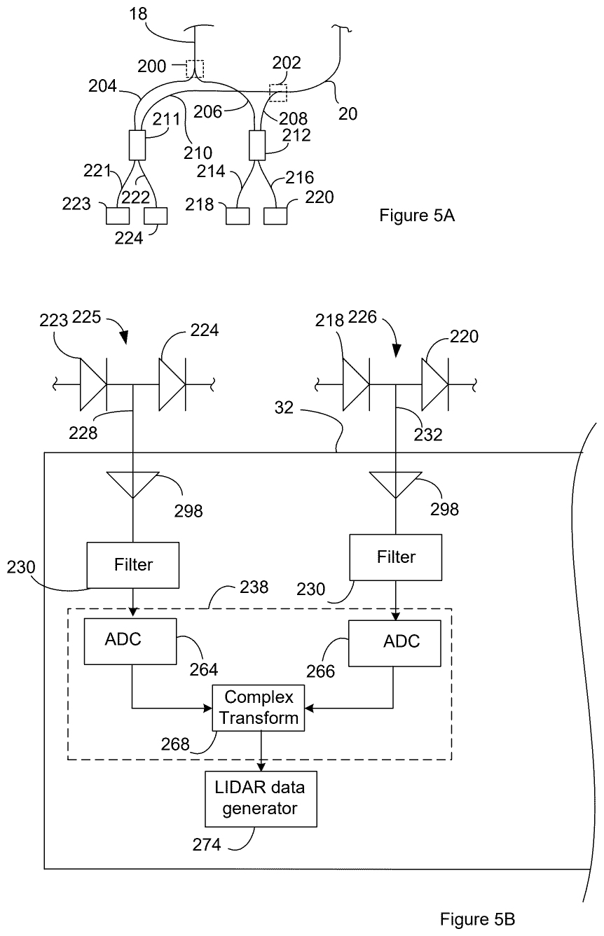

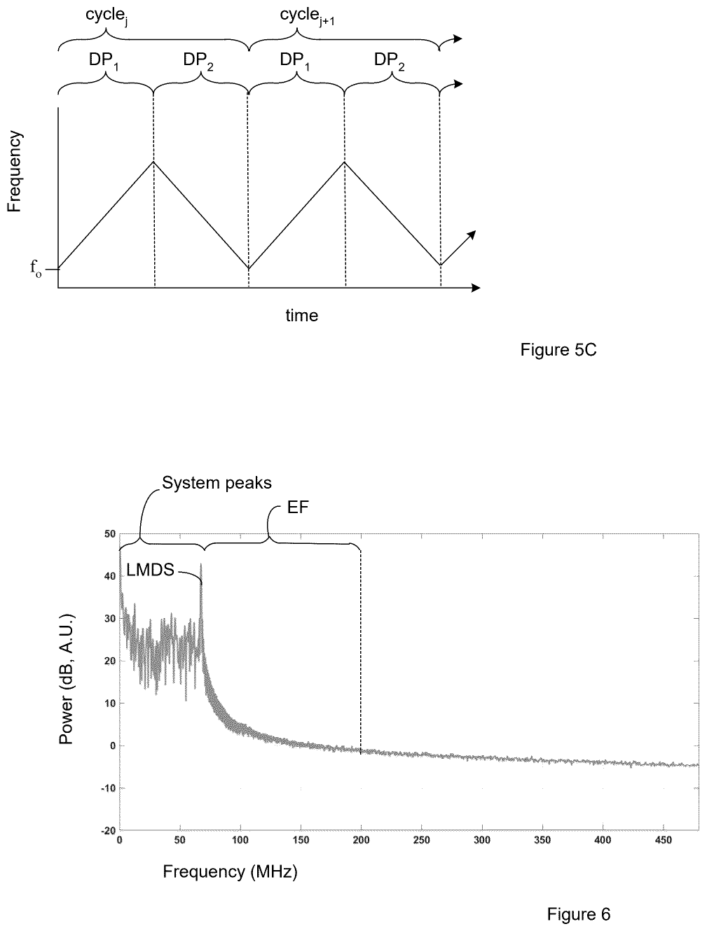

FIG. 5A through FIG. 5C illustrate an example of a suitable optical signal processor for use as the optical signal processor 22. The optical signal processor receives a comparative signal from the comparative waveguide 18 and the reference waveguide 20 shown in FIG. 1. The optical signal processor includes a second splitter 200 that divides the comparative signal carried on the comparative waveguide 196 onto a first comparative waveguide 204 and a second comparative waveguide 206. The first comparative waveguide 204 carries a first portion of the comparative signal to the light signal combiner 211. The second comparative waveguide 208 carries a second portion of the comparative signal to the second light signal combiner 212.

The optical signal processor includes a first splitter 202 that divides the reference signal carried on the reference waveguide 198 onto a first reference waveguide 204 and a second reference waveguide 206. The first reference waveguide 204 carries a first portion of the reference signal to the light signal combiner 211. The second reference waveguide 208 carries a second portion of the reference signal to the second light signal combiner 212. Accordingly, the reference signal travels an optical pathway from the splitter 16 to the light signal combiner 211 that includes the reference waveguide and the first reference waveguide 204. Additionally, the reference signal travels an optical pathway from the splitter 16 to the second light signal combiner 212 that includes the reference waveguide and the second reference waveguide 208. Each of the optical pathways from the splitter to a light signal combiner has a fixed length and the reference signal traveling the optical pathway does not exit from the LIDAR chip or from the LIDAR system.

The second light signal combiner 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light signal combiner 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light signal combiner 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light signal combiner 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light signal combiner 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first light signal combiner 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light signal combiner 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light signal combiner 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light signal combiner 212 splits the second composite signal such that the portion of the comparative signal in the first portion of the second composite signal is phase shifted by 180° relative to the portion of the comparative signal in the second portion of the second composite signal, the light signal combiner 211 also splits the composite signal such that the portion of the comparative signal in the first portion of the composite signal is phase shifted by 180° relative to the portion of the comparative signal in the second portion of the composite signal. When the second light signal combiner 212 splits the second composite signal such that the portion of the reference signal in the first portion of the second composite signal is phase shifted by 180° relative to the portion of the reference signal in the second portion of the second composite signal, the light signal combiner 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function, and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

Suitable light signal combiners that can serve as the light signal combiner 211 and/or the second light signal combiner 212 include, but are not limited to, a Multi-Mode Interference (MMI) device such as a 2×2 MMI device. Other suitable light signal combiners include, but are not limited to, adiabatic splitters, and directional couplers. In some instances, the functions of the light signal combiner are performed by more than one optical component or a combination of optical components.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal.

The first data signal is an electrical representation of the first composite signal and the second data signal is an electrical representation of the second composite signal. Accordingly, the first data signal includes a contribution from a first waveform and a second waveform, and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e., the beating in the first composite signal and in the second composite signal.

The first data signal and the second data signal are each received at a filter 230. Each filter 230 is configured to remove frequencies associated with peaks in the first data signal and/or in the second data signal that result from reflections of light signal within the LIDAR system itself rather than from an object external to the LIDAR system. In LIDAR system illustrated in FIG. 5B, the filters 270 are configured to filter analog signals.

The electronics 32 includes a beat frequency identifier 238 configured to identify a beating frequency in the first composite signal and in the second composite signal that result from reflection of the system output signal by an object external to the LIDAR system. The beat frequency identifier 238 can be configured to perform a mathematical transform on the filtered first data signal and the filtered second data signal. For instance, the mathematical transform can be a complex Fourier transform with the filtered first data signal and the filtered second data signal as inputs. Since the filtered first data signal is an in-phase component and the filtered second data signal its quadrature component, the filtered first data signal and the filtered second data signal together act as a complex data signal where the first data signal is the real component and the second data signal is the imaginary component of the input.

The beat frequency identifier 238 includes a first Analog-to-Digital Converter (ADC) 264 that receives the filtered first data signal. The first Analog-to-Digital Converter (ADC) 264 converts the filtered first data signal from an analog form to a digital form and outputs a first digital data signal. The beat frequency identifier 238 includes a second Analog-to-Digital Converter (ADC) 266 that receives the filtered second data signal from the second data line 232. The second Analog-to-Digital Converter (ADC) 266 converts the second data signal from an analog form to a digital form and outputs a second digital data signal. The first digital data signal is a digital representation of the filtered first data signal and the second digital data signal is a digital representation of the filtered second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the second Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The filters 230 can be optional. As a result, in some instances, the first data signal serves as the filtered first data signal and the second data signal serves as the filtered second data signal. Accordingly, the first Analog-to-Digital Converter (ADC) 264 can receive the first data signal and the second Analog-to-Digital Converter (ADC) 266 can receive the second data signal. The filters 230 can be in other locations within the LIDAR system. For instance, a filter 230 can be positioned on an optical pathway from the first Analog-to-Digital Converter (ADC) 264 to the mathematical transformer 268 so as to receive the first digital data signal from the first Analog-to-Digital Converter (ADC) 264 and/or a filter 230 can be positioned on an optical pathway from the second Analog-to-Digital Converter (ADC) 266 to the mathematical transformer 268 so as to receive the second digital data signal from the second Analog-to-Digital Converter (ADC) 268.

The of the mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal. The mathematical transformer 268 can execute the attributed functions using firmware, hardware or software or a combination thereof.

The electronics 32 include a LIDAR data generator 274 that receives the beat frequency of the composite signal from the mathematical transformer 268. For instance, the LIDAR data generator 274 can receive the beat frequency of the composite signal from the peak finder. The LIDAR data generator 274 processes the beat frequency of the composite signal so as to generate the LIDAR data (distance and/or radial velocity between the reflecting object and the LIDAR chip or LIDAR system). The LIDAR data generator 274 can execute the attributed functions using firmware, hardware or software or a combination thereof.

The LIDAR system can optionally include one or more light signal amplifiers in addition, or as an alternative, to any amplifiers 110. For instance, an amplifier 298 can optionally be positioned along a first data line 228 and/or a second data line 232 as illustrated in FIG. 5B. Suitable amplifiers 298 for use on the LIDAR chip, include, but are not limited to, Semiconductor Optical Amplifiers (SOAs) and transimpedance amplifiers.

FIG. 5C shows an example of a frequency versus time pattern for outgoing LIDAR signal and the resulting system output signal. The illustrated frequency versus time pattern includes a series of different chirp periods repeated in cycles. For instance, FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan.

The direction and/or rate of chirp can be different in each of the different chirp periods within a cycle. In some instances, the direction and/or rate of chirp is constant in each of the different chirp periods. As a result, the frequency can be a linear function of time. As an example, each of the cycles shown in FIG. 5C includes K chirp periods that are each associated with a period index k and are labeled DPₖ. Each cycle includes two chirp periods (labeled DPₖ with k=1 and 2) where the direction and/or rate of chirp is constant in each of the different chirp periods labeled and the direction and/or rate of chirp is different in each of the chirp periods within the same cycle. Additionally, the frequency versus time pattern is the same for the chirp periods that correspond to each other in different cycles as is shown in FIG. 5C. Corresponding chirp periods are chirp periods with the same period index. As a result, each chirp period DP1 can be considered corresponding chirp periods and the associated frequency versus time patterns are the same in FIG. 5C. At the end of a cycle, the electronics return the frequency to the same frequency level at which it started the previous cycle.

During the chirp period DP1, and the chirp period DP2, the electronics operate the light source such that the frequency of the outgoing LIDAR signal and the resulting system output signal changes at a linear rate a. The direction of the frequency change during the chirp period DP1 is the opposite of the direction of the frequency change during the chirp period DP2.

The base frequency of the system output signal (fₒ) can be the frequency of the system output signal at the start of a cycle. The illustrated frequency versus time pattern is an example and other frequency versus time patterns can be used in conjunction with the use of normalized beat frequencies. As non-limiting examples, the frequency versus time pattern can be a sawtooth waveform with slow up-chirp and fast down chirp, or can be multi-segment, with two segments of shallow up-chirps and one down-chirp. The use of the normalized beat frequency can apply to each of the different patterns independent of the modulation pattern. Additionally, the illustrated frequency versus time pattern can include additional chirp periods in the cycles. The chirp periods in the cycles of the illustrated frequency versus time pattern each result in a composite signal beat frequency used in the example calculation of LIDAR data as described below.

The frequency output from the peak finder associated with the Complex Fourier transform represents the beat frequency of the composite signals that each includes a comparative signal beating against a reference signal. The frequency provided by the peak finder of the mathematical transformer 268 during a chirp period where electronics increase the frequency of the outgoing LIDAR signal during the chirp period such as occurs in chirp period DP1 of FIG. 5C can be represented by f_{ub}. The frequency provided by the peak finder of the mathematical transformer 268 during a chirp period where electronics decrease the frequency of the outgoing LIDAR signal such as occurs in chirp period DP2 of FIG. 5C can be represented by f_{db}.

The beat frequencies (f_{LDP}) from two or more different chirp periods in the same cycle can be combined to generate the LIDAR data. For instance, the beat frequency determined from DP1 in FIG. 1C can be combined with the beat frequency determined from DP2 in FIG. 1C to determine the LIDAR data for a sample region. As an example, the following equation applies during a data period where electronics increase the frequency of the outgoing LIDAR signal during the data period such as occurs in data period DP1 of FIG. 1C: f_{ub}=−f_{d}+ατ where f_{ub} is the beat frequency determined from the output of the mathematical transformer 170, t represents the round-trip time of the system output signal from the LIDAR system to the reflecting object and back to the LIDAR system, f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the LIDAR system is assumed to be the positive direction, and c is the speed of light. The following equation applies during a data period where electronics decrease the frequency of the outgoing LIDAR signal such as occurs in data period DP2 of FIG. 1C: f_{db}=−f_{d}−α τ where fab is the beat frequency determined from the output of the mathematical transformer 170. In these two equations, fa and t are unknowns. The These two equations can be solved for the two unknowns. The radial velocity for the sample region then be determined from the Doppler shift (ν=c*f_{d}/(2f_{c})) and/or the separation distance for that sample region can be determined from c*τ/2. Since the LIDAR data can be generated for each corresponding frequency pair output by the transform, separate LIDAR data can be generated for each of the objects in a sample region. Accordingly, the electronics can determine more than one radial velocity and/or more than one radial separation distance from a single sampling of a single sample region in the field of view.

FIG. 6 illustrates an example of the output of the mathematical transformer 268 when an object does not reflect the system output signal and the LIDAR system excludes the filters 270. As a result, FIG. 6 shows the power of the data signal as a function of frequency when an external object is not present to reflect the system output signal. The illustrated amplitude versus frequency function includes peaks labeled system peaks. The system peaks occur as a result of misdirected light from the outgoing LIDAR signal being included in the composite signal without traveling the LIDAR path that is designed for the signals to travel through the LIDAR system. The LIDAR path can be an optical pathway from the splitter to the location where the portion of the outgoing LIDAR signal is transmitted from the LIDAR system as the system output signal, to an external object, back to the LIDAR system and then to the light signal combiner. The portion of the LIDAR path between the splitter and the object can include one or more misdirection sources that each reflects a misdirected portion of the first portion of the outgoing LIDAR signal that serves as a misdirected signal. For instance, the LIDAR system can include one or more misdirection sources that each reflects a misdirected portion of the outgoing LIDAR signal as the outgoing LIDAR signal travels from the splitter 16 to the external object. The misdirected portion of the outgoing LIDAR signal can serve as a misdirected signal that travels an optical path from the misdirection source to a light signal combiner. In some instances, the misdirected signal does not leave the LIDAR assembly or the LIDAR system. Accordingly, light from the misdirected signal is often not included in the system output signal. As a result, light from the misdirected light is often not reflected by an object located in a sample region.

Example sources of a misdirected signal (misdirection sources) include, but are not limited to, reflections, cross talk between optical components in the LIDAR system, and light scattered by component(s) of the LIDAR system. In some instances, a misdirection source reflects a reflected portion of the outgoing LIDAR signal that serves as the misdirected signal. FIG. 4 is marked MDS to show examples of locations where undesired reflections of light that can occur. As an example, FIG. 4 includes a dashed line that represents a reflection at the input surface of a lens that serves as a beam shaper 130 and a dashed line that represents a reflection at the output surface of the lens. In some instances, a misdirection source reflects more than 0.001%, or 0.01% and less than 0.4%, or 0.8% of the power of the outgoing LIDAR signal received by the misdirection source. Light reflected by a misdirection source can serve as a misdirection signal that travels back on one or more optical pathways through the LIDAR system as if it were light from a system return signal reflected by an object outside of the LIDAR system. As a result, one or more misdirection signals can be received by a processing unit 20 and can be included in a comparative signal where the one or more misdirection signals can each beat against the reference signal. As a result, the misdirection signals can each be the source of a system peak in FIG. 6. As is evident from FIG. 6, the system peaks represent noise in the output of the transform mechanism 168. The system peaks can reduce the signal-to-noise ratio (SNR) in the output of the mathematical transformer 268 for objects that are close to the LIDAR system.

In the LIDAR system of FIG. 4, when the one or more beam scanners 134 is a mirror, the output surface of the lens can serve as the misdirection source that is optically furthest from the light source 4 and/or closest to a reflecting object located external to the LIDAR system (the last misdirection source or last MDS). As an example, the last misdirection source can be the misdirection source with the shortest time for the outgoing LIDAR signal to travel between misdirection source and the location where the outgoing LIDAR signal is transmitted from the LIDAR system as the system output signal. Depending on the configuration of the LIDAR system, other components of a LIDAR system can serve as the last misdirection source. In FIG. 6, the system peak labeled LMDS shows the power of the data signal resulting from the last misdirection source (LMDS). For instance, the system peak labeled LMDS can represent the power of power of the data signal resulting from reflection of the outgoing LIDAR system by the lens in the LIDAR system of FIG. 4.

In FIG. 6, the system peak labeled LMDS has a tail that elevates the noise floor of the output of the mathematical transformer 268. For instance, the portion of the curve shown in FIG. 6 labeled EF represents an elevated noise floor resulting from reflection of the outgoing LIDAR system by the LMDS. Since lower beat frequencies result from an external object being closer to the LIDAR system, the elevated noise floor can interfere with the calculation of LIDAR data for objects that are close to the LIDAR system. As a result of this interference, a lower frequency limit is shown at a beat frequency of about 100 MHz to 200 MHz. In some instances, a minimum operation distance for the LIDAR system is around 3 m to 10 m. The minimum operation distance can be the minimum distance between the LIDAR system and an external object for which the LIDAR system reliably provides LIDAR data. The distances between the LIDAR system and the object can be measure relative to the LMDS. As a result, the minimum operation distance can be the minimum distance between the LMDS and an external object for which the LIDAR system reliably provides LIDAR data. Since objects positioned around 3 m to 10 m from the LIDAR system can provide beat frequencies around 100 to 200 MHz, the elevated noise floor caused by the misdirection sources can interfere with generation of reliable LIDAR data for objects at or near the minimum operation distance from the LIDAR system.

The range of beat frequency values that the LIDAR system can reliably calculate extends from the lower beat frequency limit to an upper beat frequency limit. The lower beat frequency limit can represent the minimum beat frequency where the beat frequency can be accurately determined. The upper beat frequency limit can represent the maximum beat frequency where the beat frequency can be accurately determined. In the image of FIG. 6, elevated noise floor shifts the lower beat frequency limit to around 100 MHz to 200 MHz even though the last misdirection source (LMDS) provides a frequency peak at around 70 MHz.

The filters 230 illustrated in FIG. 5B can be selected to reduce the elevated noise floor (ET) shown in FIG. 6. For instance, the filters 230 can be selected to filter frequencies below a lower frequency threshold from a data signal. In some instances, the lower frequency threshold is greater than or equal to the frequency labeled LMDS. In some instances, the lower frequency threshold is greater than or equal to the frequency labeled LMDS and less than or equal to the lower frequency limit. In the example of FIG. 6, a suitable lower frequency threshold includes, but is not limited to, lower frequency thresholds greater than or equal to 70 MHz, 80 MHz, or 90 MHz and less than our equal to 100 MHz, 150 MHz, or 200 MHz. The reduction of the elevated noise floor reduces the lower frequency limit. Accordingly, the removal or reduction of the elevated noise floor permits the generation of reliable LIDAR data for external objects that are closer to the LIDAR system and/or have a lower radial velocity relative to the LIDAR system. Suitable lower frequency thresholds include, but are not limited to, lower frequency thresholds greater than or equal to 10 MHz, 20 MHz, or 50 MHz and less than our equal to 100 MHz, 150 MHz, or 200 MHz. Suitable filters 230 include, but are not limited to, high-pass filters.

In some instances, the LIDAR system employs bin-zeroing in addition to the filters 230. When the mathematical transform is a Fourier transform such as a complex Fourier transform, a real Fourier transform, a complex Fast Fourier Transform (FFT), or a real Fast Fourier Transform (FFT), the beat frequency identifier 238 and/or the mathematical transformer 268 can perform the bin-zeroing such that the frequencies in all or a portion of the Fourier transform bins that contain a frequency less than or equal to the lower frequency limit before the peak finder applies a peak finding algorithm to the output of the mathematical transformer 268. For instance, before the peak finder applies the peak finding algorithm to the output of the mathematical transformer 268, the beat frequency identifier 238 and/or the mathematical transformer 268 can zero the frequencies in the FFT bins that contain a span of frequency values that include or consist or frequencies less than or equal to the lower frequency limit. As a result, the peak finding algorithm is applied to the bin-zeroed output of the FFT.

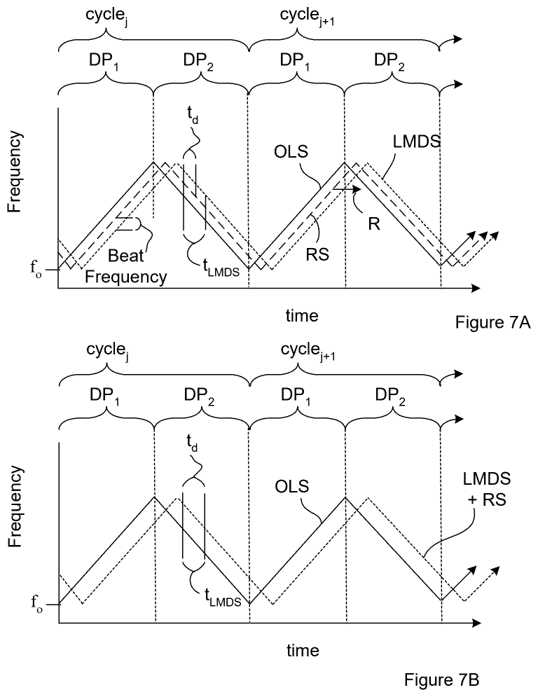

Additionally, the total detection range of the LIDAR system can be increased by increasing the time for the reference signal to travel from the splitter 16 to a light signal combiner such as the light signal combiner 211 and/or the second light signal combiner 212. To illustrate this, FIG. 7A illustrates the frequency versus time patterns for three different signals. The signal labeled OLS can represent the frequency versus time patterns of the outgoing LIDAR signal at the splitter 16. The signal labeled RS can represent the frequency versus time patterns of the outgoing LIDAR signal at the light signal combiner. Accordingly, the time delay between the reference signal being taken from the outgoing LIDAR signal at the splitter 16 and arriving at the light signal combiner is represented by the time labeled t_{d}. The signal labeled LMDS can represent the frequency versus time patterns of the misdirected light signal reflected by the LMDS at the light signal combiner. Accordingly, the time delay between the outgoing LIDAR signal being output from the splitter 16, being reflected by the LMDS and arriving at the light signal combiner is represented by the time labeled t_{LMDS}. Since a beat frequency is the difference between signal frequencies, the beat frequency that results from the signal labeled LMDS beating against the reference signal is labeled “beat frequency.” FIG. 7A shows that the LDMS is a source of a beat frequency due to the frequency difference between the LMDS and the reference signal.

Increasing the time for the reference signal to travel from the splitter 16 to the light signal combiner (t_{d}) can be illustrated by moving the signal labeled RS in FIG. 7A to the right as illustrated by the arrow labeled R in FIG. 7A. FIG. 7B illustrates this time increased until t_{d} equals t_{LMDS}. As a result, FIG. 7B illustrates the condition where the time for the reference signal to travel from the splitter 16 to the light signal combiner (t_{d}) is equal to the time for the outgoing LIDAR signal to be output from the splitter 16, be reflected by the LMDS and arrive at the light signal combiner. As a result, the signal labeled RS overlaps with the signal labeled LMDS. Since there is not a frequency different between the signal labeled RS and the signal labeled LMDS, the signal labeled LMDS does not beat against the reference signal.

A comparison of FIG. 7A and FIG. 7B shows that increasing the time for the reference signal to travel from the splitter 16 to the light signal combiner (t_{d}) shifts the beat frequencies to lower values. Accordingly, increasing the time for the reference signal to travel from the splitter 16 to the light signal combiner (t_{d}) shifts the beat frequency for the last misdirection source (LMDS) to a lower frequency. Since last misdirection source (LMDS) can be the source of the lower frequency limit, shifting the beat frequency for the last misdirection source (LMDS) to a lower frequency reduces the lower frequency limit.

Additionally, the upper frequency limit is generally determined and/or limited by the electronics. For instance, the beat frequency of the composite signal increases as an external object becomes further from the LIDAR system. However, higher beat frequencies require analog-to-digital converters, such as the first Analog-to-Digital Converter (ADC) 264 and/or the second Analog-to-Digital Converter (ADC) 266, with higher sample rates. The costs of analog-to-digital converters increase with the sampling rate. As a result, the analog-to-digital converters can determine the upper frequency limit.

Shifting the beat frequencies to lower frequencies by increasing the delay in the reference signal traveling from the splitter 16 to the light signal combiner (t_{d}) does not shift the upper frequency limit. As a result, shifting the beat frequencies to lower frequencies increases the total beat frequency span that the LIDAR system can reliably detect. As an example, FIG. 6 illustrates the lower frequency limit at around 200 MHz. If the upper frequency limit is 1 gHz, the total beat frequency span that the LIDAR system can reliably detect is around 800 MHZ. If the lower frequency limit is shifted to 100 MHZ, the total beat frequency span that the LIDAR system can reliably detect is around 900 MHz by increasing the delay of the reference signal and/or reducing the noise floor of the output of the mathematical transformer 268. This increase in the total beat frequency span that the LIDAR system can reliably detect increases the range of distances and radial velocities for which the LIDAR system can be used.

The LIDAR system can include one or more mechanisms for delaying the reference signal. For instance, a portion of the reference waveguide 20 can be a spiral waveguide 280 as shown in FIG. 1. The spiral waveguide 280 can have a length that provides the reference waveguide 20 with the length needed to provide the desired level of delay between a splitter and a light signal combiner. While FIG. 1 illustrates the use of a spiral waveguide to provide the reference waveguide 20 with a length that provides the desired level of delay, a spiral waveguide may not be required to achieve the desired length of the reference waveguide 20 and/or delay between a splitter and a light signal combiner.

In some instances, the LIDAR system is constructed such that the time for the reference signal to travel from a splitter a light signal combiner (t_{d}) is greater than 1 picosend, 50 picoseconds, or 200 picoseconds and less than 800 picoseconds, 900 picoseconds or 1 nanosecond. Additionally, or alternately, in some instances, the LIDAR system is constructed such that the optical pathway that the reference signal travels from a splitter to a light signal combiner (t_{d}) has a length greater than 0.086 mm, 1 mm, or 10 mm and less than 0.05 m, or 0.086 m. Additionally or alternately, in some instances, the time for the reference signal to travel from the splitter the light signal combiner (t_{d}) is more than 30%, 60%, or 70% and less than 80%, 90%, or 100% of the time for an outgoing LIDAR signal to travel from the splitter, be reflected by the last misdirection source (LMDS) and arrive at the light signal combiner (t_{LMDS}). In some instances, the splitter receives an outgoing LIDAR signal; the system output signal and the reference signal include light from the outgoing LIDAR signal; and the light signal combiner combines the reference signal with a comparative signal that includes light from the system output signal that has been reflected by an object external to the LIDAR system.

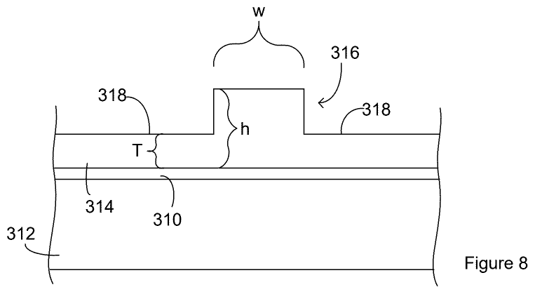

FIG. 8 is a cross section of a portion of a LIDAR chip that includes a waveguide construction that is suitable for use in LIDAR chips constructed from silicon-on-insulator wafers. A ridge 316 of the light-transmitting medium extends away from slab regions 318 of the light-transmitting medium. The light signals are constrained between the top of the ridge 316 and the buried oxide layer 310.

The dimensions of the ridge waveguide are labeled in FIG. 8. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction disclosed in the context of FIG. 8 is suitable for all or a portion of the waveguides on LIDAR chips constructed according to FIG. 1A through FIG. 1C.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

The light source 4 that is interfaced with the utility waveguide 12 can be a laser chip that is separate from the LIDAR chip and then attached to the LIDAR chip. For instance, the light source 4 can be a laser chip that is attached to the chip using a flip-chip arrangement. Use of flip-chip arrangements is suitable when the light source 4 is to be interfaced with a ridge waveguide on a chip constructed from silicon-on-insulator wafer. Alternately, the utility waveguide 12 can include an optical grating (not shown) such as Bragg grating that acts as a reflector for an external cavity laser. In these instances, the light source 4 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017, and in U.S. Pat. No. 5,991,484 issued on Nov. 23 1999; each of which is incorporated herein in its entirety. When the light source 4 is a gain element or laser chip, the electronics 32 can change the frequency of the outgoing LIDAR signal by changing the level of electrical current applied to through the gain element or laser cavity.

Suitable electronics 32 can include, but are not limited to, an electronic controller that includes or consists of analog electrical circuits, digital electrical circuits, processors, microprocessors, digital signal processors (DSPs), Application Specific Integrated Circuits (ASICs), Field Programmable Gate Arrays (FPGAs), computers, microcomputers, or combinations suitable for performing the operation, monitoring and control functions described above. In some instances, the electronic controller has access to a memory that includes instructions to be executed by the electronic controller during performance of the operation, control and monitoring functions. Although the electronics are illustrated as a single component in a single location, the electronics can include multiple different components that are independent of one another and/or placed in different locations. Additionally, all or a portion of the disclosed electronics can be included on the chip including electronics that are integrated with the chip. All or a portion of the beat frequency identifier 238, mathematical transformer 268, and LIDAR data generator 274 can execute the attributed functions using firmware, hardware, software or a combination thereof.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demulitplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demulitplexers, tunable multiplexers.

Although the LIDAR system is disclosed as using complex signals such as the complex data signal, the LIDAR system can also use real signals. As a result, the mathematical transform can be a real transform and the components associated with the generation and use of the quadrature components can be removed from the LIDAR system. As a result, the LIDAR system can use a single light signal combiner, a single filter, a single light sensor such as a single balanced detector, and a single analog-to-digital converter. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system that includes a signal splitter configured to receive an outgoing LIDAR signal,
the LIDAR system being configured to transmit a system output signal from the LIDAR system, the system output signal including light from the outgoing LIDAR signal received by the splitter;
the LIDAR system including a light signal combiner configured to combine light that returns to the LIDAR system from the system output signal with light from a reference signal so as to generate a composite signal beating at a composite beat frequency,
the reference signal including light from the outgoing LIDAR signal received by the splitter, a length of an optical pathway from the splitter to the light signal combiner being greater than 1 picosecond and less than 1 nanosecond.

2. The system of claim 1, wherein the splitter is configured to output a portion of the outgoing LIDAR signal that travels an optical pathway from the splitter to a location where the portion of the outgoing LIDAR signal is transmitted from the LIDAR system as the system output signal, the optical pathway including a misdirection source that reflects a misdirected portion of the first portion of the outgoing LIDAR signal that serves as a misdirected signal, the misdirected signal being received at the light signal combiner.

3. The system of claim 2, wherein the misdirection source is a surface of the lens.

4. The system of claim 2, wherein a time for the reference signal to travel the optical pathway from the splitter to the light signal combiner is greater than or equal to 50% and less than or equal to 100% of a time for light in the misdirected signal to travel from the splitter, to the misdirection source, and to the light signal combiner.

5. The system of claim 2, wherein the misdirection source is a last one of multiple misdirection sources included in the LIDAR system, each misdirection source reflecting one of multiple misdirected portions of the first portion of the outgoing LIDAR signal that serves as one of multiple misdirected signals, each of the misdirected signals being received at the light signal combiner.

6. The system of claim 5, wherein the last misdirection source is the misdirection source where a time for the outgoing LIDAR signal to travel between misdirection source and the location where the outgoing LIDAR signal is transmitted from the LIDAR system as the system output signal is the shortest.

7. The system of claim 1, wherein the splitter is configured to output the reference signal.

8. The system of claim 1, wherein the LIDAR system includes a high-pass filter that receives an electronic version of the composite signal.

9. A system, comprising:
a LIDAR system that includes a signal splitter configured to receive an outgoing LIDAR signal,
the LIDAR system being configured to transmit a system output signal from the LIDAR system, the system output signal including light from the outgoing LIDAR signal received by the splitter;
the LIDAR system including a light signal combiner configured to combine light that returns to the LIDAR system from the system output signal with light from a reference signal so as to generate a composite signal beating at a composite beat frequency,
the reference signal including light from the outgoing LIDAR signal received by the splitter, the LIDAR system being constructed such that a time for the reference signal to travel from the splitter to the light signal combiner being greater than 1 picosecond and less than 1 nanosecond.

10. The system of claim 9, wherein the splitter is configured to output a portion of the outgoing LIDAR signal that travels an optical pathway from the splitter to a location where the portion of the outgoing LIDAR signal is transmitted from the LIDAR system as the system output signal, the optical pathway including a misdirection source that reflects a misdirected portion of the first portion of the outgoing LIDAR signal that serves as a misdirected signal, the misdirected signal being received at the light signal combiner.

11. The system of claim 9, wherein the misdirection source is a surface of the lens.

12. The system of claim 9, wherein the time for the reference signal to travel from the splitter to the light signal combiner is greater than or equal to 50% and less than or equal to 100% of a time for light in the misdirected signal to travel from the splitter, to the misdirection source, and to the light signal combiner.

13. The system of claim 9, wherein the misdirection source is a last one of multiple misdirection sources included in the LIDAR system, each misdirection source reflecting one of multiple misdirected portions of the first portion of the outgoing LIDAR signal that serves as one of multiple misdirected signals, each of the misdirected signals being received at the light signal combiner.

14. The system of claim 13, wherein the last misdirection source is the misdirection source where a time for the outgoing LIDAR signal to travel between misdirection source and the location where the outgoing LIDAR signal is transmitted from the LIDAR system as the system output signal is the shortest.

15. The system of claim 9, wherein the splitter is configured to output the reference signal.

16. A system, comprising:
a LIDAR system that includes a signal splitter configured to receive an outgoing LIDAR signal,
the LIDAR system being configured to transmit a system output signal from the LIDAR system, the system output signal including light from the outgoing LIDAR signal received by the splitter;
the LIDAR system including a light signal combiner configured to combine light that returns to the LIDAR system from the system output signal with light from a reference signal so as to generate a composite signal beating at a composite beat frequency,
the reference signal including light from the outgoing LIDAR signal received by the splitter;
the splitter being configured to output a portion of the outgoing LIDAR signal that travels an optical pathway from the splitter to a location where the portion of the outgoing LIDAR signal is transmitted from the LIDAR system as the system output signal,
the optical pathway from the splitter to the location where the portion of the outgoing LIDAR signal is transmitted from the LIDAR system including a misdirection source that reflects a misdirected portion of the first portion of the outgoing LIDAR signal that serves as a misdirected signal, the misdirected signal being received at the light signal combiner,
the LIDAR system constructed such that a time for the reference signal to travel from the splitter to the light signal combiner is greater than or equal to 50% and less than or equal to 100% of a time for light in the misdirected signal to travel from the splitter, to the misdirection source, and to the light signal combiner.
